(19) United States
(12) Patent Application Publication
(10) Pub. No.: US 2025/0332535 A1
(43) Pub. Date: Oct. 30, 2025

(54) METHOD AND APPARATUS FOR LOW-TEMPERATURE SEPARATION OF A GAS CONTAINING CO2 TO PRODUCE A CO2-RICH FLUID

(71) Applicant: L'Air Liquide, Societe Anonyme pour l'Etude et l’Exploitation des Procedes Georges Claude, Paris (FR)

(72) Inventors: Michele MURINO, Champigny Sur Marne (FR); Ludovic GRANADOS, Champigny Sur Marne (FR); Abigail BONIFACIO, Houston, TX (US)

(21) Appl. No.: 18/866,732

(22) PCT Filed: May 16, 2023
(86) PCT No.: PCT/EP2023/063084

§ 371 Date: Nov. 18, 2024

Related U.S. Application Data
(60) Provisional application No. 63/343,281, filed on May 18, 2022.

(30) Foreign Application Priority Data
Jul. 29, 2022 (FR) FR 2207891
Jul. 29, 2022 (FR) FR 2207892

(51) Int. Cl. B01D 53/00; B01D 5/00

(52) U.S. Cl. CPC B01D 53/002; B01D 5/006; B01D 2257/504

(57) ABSTRACT

The invention relates to a method for the low-temperature separation of a gas containing CO₂ in order to produce a CO₂-rich fluid, in which method a gas containing CO₂ and at least one component lighter than CO₂ is compressed in a compressor comprising at least two stages, the gas being cooled downstream of at least one of the stages in a cooler and by exchanging heat with air and then being cooled in a first heat exchanger, the gas cooled in the first heat exchanger is separated at low temperature by partial condensation and/or distillation in order to produce a fluid rich in CO₂ and depleted in the component lighter than CO₂ and a gas depleted in CO₂ and enriched in the component lighter than CO₂. The gas depleted in CO₂ is first heated in the first heat exchanger and then in the cooler before being expanded in a turbine.

### CROSS REFERENCE TO RELATED APPLICATIONS

This application is a § 371 of International PCT Application PCT/EP2023/063084, filed May 16, 2023, which claims the benefit of FR2207891, filed Jul. 29, 2022, FR2207892, filed Jul. 29, 2022, and U.S. Provisional 63/343,281, filed May 18, 2022, all of which are herein incorporated by reference in their entireties.

### FIELD OF THE INVENTION

The present invention relates to a process and apparatus for the low-temperature separation of a gas containing CO₂ to produce a CO₂-rich fluid. The mixture to be separated contains CO₂ and at least one component lighter than CO₂, such as carbon monoxide, hydrogen, nitrogen, oxygen or methane.

In particular, the process can treat a gas resulting from combustion, for example an oxycombustion process, to form a CO₂-rich product, for example a product containing at least 80 mol % of CO₂, indeed even at least 90 mol % of CO₂.

### BACKGROUND OF THE INVENTION

A gas containing CO₂, for example may include a waste gas from an H₂ pressure swing adsorber (PSA) or a CO₂ PSA.

A low-temperature separation operates at temperatures of less than 0° C., indeed even of less than −40° C.

### SUMMARY OF THE INVENTION

According to certain embodiments of the invention, there is provided a process for the low-temperature separation of a gas containing CO₂ to produce a CO₂-rich fluid, in which a gas containing CO₂ and at least one component lighter than CO₂ is compressed in a compressor comprising at least two stages, the gas being cooled downstream of a last of the stages, first in a cooler and subsequently cooled by heat exchange with water to ambient temperature, or the reverse, and subsequently cooled in a first heat exchanger, the gas cooled in the first heat exchanger is separated at low temperature by partial condensation to produce a liquid enriched in CO₂ and depleted in the component lighter than CO₂ and a gas depleted in CO₂ and enriched in the component lighter than CO₂, the gas depleted in CO₂ is first heated in the first heat exchanger and subsequently in the cooler before being expanded in a turbine and the liquid enriched in CO₂ is separated by distillation to form at least one CO₂-rich fluid.

According to other optional characteristics:
the at least one CO₂-rich fluid is a liquid and at least a part of the CO₂-rich fluid is vaporized in the first heat exchanger,
the at least one vaporized CO₂-rich fluid is compressed in a compressor driven by the turbine,
the liquid enriched in CO₂ is expanded and sent to the top of a stripping column and the at least one CO₂-rich fluid is a bottom liquid from the stripping column,
the liquid enriched in CO₂ is sent to the top of a scrubbing column and the liquid from the scrubbing column feeds a distillation column,
a top gas from the distillation column is compressed in a compressor driven by the turbine,
the gas depleted in CO₂ goes into the cooler at a temperature greater than ambient temperature, for example greater than 30° C.,
the gas to be separated is separated by partial condensation (S) to produce the gas depleted in CO₂ and also a liquid; the liquid is separated by distillation in a distillation column to produce the CO₂-rich fluid, which is preferably a CO₂-rich liquid,
at least a part of the cold is provided by a closed refrigeration cycle comprising at least one cycle compressor driven by the turbine, and/or
the at least one CO₂-rich fluid is a gas which is heated in the first heat exchanger before being compressed.

According to another subject matter of the invention, there is provided an apparatus for the low-temperature separation of a gas containing CO₂ to produce a CO₂-rich fluid comprising a compressor comprising at least two stages, a cooler, a water cooler, a first heat exchanger, a phase separator, a turbine and at least one distillation column, means for sending a gas containing CO₂ and at least one component lighter than CO₂ to the compressor comprising at least two stages, means for sending the compressed gas from the compressor in order to be cooled in the cooler and the water cooler, means for sending the gas cooled in the cooler and the water cooler into the first heat exchanger, means for sending the gas cooled in the first heat exchanger to the phase separator to form a liquid enriched in CO₂ and depleted in the component lighter than CO₂ and a gas depleted in CO₂ and enriched in the component lighter than CO₂, means for sending the gas depleted in CO₂ to be heated first in the first heat exchanger and subsequently in the cooler, means for sending the gas depleted in CO₂ heated in the cooler to be expanded in the turbine and means for sending the liquid enriched in CO₂ to be separated in the at least one distillation column to form at least one CO₂-rich fluid.

According to other optional aspects:
the apparatus comprises a cycle compressor coupled to the turbine,
the apparatus comprises a CO₂-rich product compressor coupled to the turbine,
a part of the gas compressed in the product compressor is liquefied and returned to the at least one distillation column as reflux, and/or
the apparatus comprises a distillation column fed with the liquid enriched in CO₂ coming from the phase separator and an NOx removal column fed with a bottom liquid from the distillation column.

According to another subject matter of the invention, there is provided an apparatus for the low-temperature separation of a gas containing CO₂ to produce a CO₂-rich fluid comprising a compressor comprising at least two stages, a first heat exchanger, a cooler, a distillation system comprising at least one phase separator and/or at least one distillation column, a turbine, means for sending a gas containing CO₂ and at least one component lighter than CO₂ to be compressed in the compressor, means for sending compressed gas to be cooled downstream of at least one of the stages in the cooler, means for sending the compressed and cooled gas to be cooled in the first heat exchanger, means for sending the gas cooled in the first heat exchanger to be separated by partial condensation and/or distillation to produce a fluid rich in CO₂ and depleted in the component lighter than CO₂ and a gas depleted in CO₂ and enriched in the component lighter than CO₂, means for sending the gas depleted in CO₂ to be heated first in the first heat exchanger and subsequently in the cooler and means for sending the gas depleted in CO₂ and heated in the cooler to be expanded in the turbine.

### BRIEF DESCRIPTION OF THE DRAWINGS

These and other features, aspects, and advantages of the present invention will become better understood with regard to the following description, claims, and accompanying drawings. It is to be noted, however, that the drawings illustrate only several embodiments of the invention and are therefore not to be considered limiting of the invention's scope as it can admit to other equally effective embodiments.

FIG. 1 diagrammatically represents a process according to the invention.

FIG. 2 diagrammatically represents a process according to the invention.

### DETAILED DESCRIPTION OF THE INVENTION

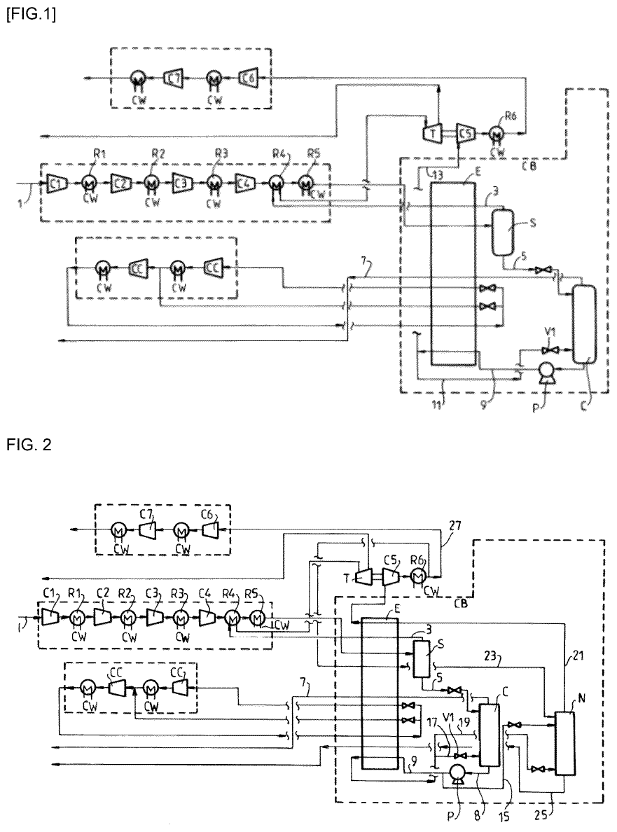

FIG. 1 diagrammatically represents a process using a single distillation column to remove a component lighter than CO₂ in a first column.

A gas flow 1 is compressed in a multistage compressor, in this instance having four stages C1, C2, C3, C4, in this instance with a cooler R1, R2, R3 between each pair of stages and two coolers R4, R5 downstream of the last stage. This flow 1 can, for example, be the waste from an H₂ or CO₂ PSA and can be compressed up to at least 35 bar abs in the stages of the compressor C1 to C4. The coolers R1 to R3 are cooled solely by cooling water CW, just like cooler R5.

The gas flow 1 contains CO₂ and at least one lighter component which can be hydrogen, carbon monoxide, nitrogen or oxygen. In this example, the gas flow is rich in nitrogen. Preferably, the gas flow 1 contains less than 1 mol % of methane.

The gas flow cooled in the two coolers R4, R5 downstream of the last stage is cooled down to a temperature of less than −50° C. in a first heat exchanger E by heat exchange with at least one fluid resulting from the cold separation. This exchanger E can be of plate and fin type made of brazed aluminum.

The gas flow 1 is partially condensed in the first heat exchanger E and the two-phase flow formed is separated in a phase separator S, forming a gas 3 enriched in the at least one lighter component, in this instance at least nitrogen. This gas is heated in the first exchanger E up to a temperature greater than ambient temperature, for example greater than 30° C., and is subsequently heated in the first cooler R4 directly following the last stage C4 of the compressor from a temperature of 30° C. up to a temperature of 100° C., being the only cooling fluid sent to this first cooler R4. Subsequently, the gas cooled in the first cooler R4 is cooled in a second cooler R5 against cooling water CW to an ambient temperature of less than 40° C., indeed even of less than 30° C.

Alternatively, the gas flow 3 enriched in the at least one light component can cool the compressed gas in the second cooler R5, the first being cooled by water.

Alternatively or in addition, the flow enriched in the at least one light component can cool the compressed gas in a cooler R1, R2, R3 between two stages of the compressor.

Thus, the gas 3 to be expanded in a turbine T is preheated against the gas compressed in the compressor C1 to C4, so that the heat of compression makes it possible to produce more energy in the turbine.

The gas flow 3 enriched in light component heated in the first cooler R4 is at 8 bar and is expanded in the turbine T from this pressure down to approximately atmospheric pressure. The gas flow enriched in light component 3 can subsequently be used to regenerate adsorbents for drying the gas feeding the PSA to produce the flow 1.

The liquid 5 from the phase separator S is expanded and subsequently sent to the top of a distillation column C which is a stripping column from which a liquid 9 enriched in CO₂ and depleted in the at least one light component is withdrawn at the bottom. This liquid can form at least a part of the product of the process. At least a part of the liquid is pressurized by a pump P and can be sent to be vaporized in the first heat exchanger E, a part 11 of the vaporized liquid optionally being sent to the bottom of the column C as reboiling. At least a part 13 of the vaporized liquid can be compressed in a product compressor C5 driven by the turbine T to produce a CO₂-rich gas. The gas is subsequently compressed by other compression stages C6, C7, with a water cooler CW between each pair of stages (R6 between C5 and C6), and a last cooler downstream of stage C7. The gas compressed in C7 constitutes the CO₂-rich gaseous product in this example.

The top gas 7 from the column C is heated in the first exchanger E.

The exchanger E, the phase separator S and the column C are inside a thermally insulated chamber CB.

Two means of cold production are used:
A closed cycle in which CO₂ is compressed in a cycle compressor CC and returned to the first heat exchanger, where it is cooled, liquefied, separated and expanded in two different valves to form two flows at 5.5 and 9.5 bar abs. These two flows are heated in the first heat exchanger E to provide cold and are then returned to the cycle compressor CC.
Vaporization of the liquid 9 in the exchanger E.

Obviously, the system may comprise several phase separators, in series and/or in parallel and upstream of the distillation, and also at least one distillation column.

If the system does not comprise a column separator, the gas expanded in the turbine will be taken at the top of the distillation column.

FIG. 2 diagrammatically represents a process using two columns to remove a component lighter than CO₂ in a first column and a component heavier than CO₂ in a second column.

A gas flow 1 is compressed in a multistage compressor, in this instance having four stages C1, C2, C3, C4, in this instance with a cooler R1, R2, R3 between each pair of stages and two coolers R4, R5 downstream of the last stage. This flow 1 can, for example, be the waste from an H₂ or CO₂ PSA and can be compressed up to at least 35 bar abs in the stages of the compressor C1 to C4. The coolers R1 to R3 are cooled solely by cooling water CW, just like cooler R5.

The gas flow 1 contains CO₂ and at least one lighter component which can be hydrogen, carbon monoxide, nitrogen or oxygen. In this example, the gas flow is rich in nitrogen. Preferably, the gas flow 1 contains less than 1 mol % of methane.

The gas flow cooled in the two coolers R4, R5 downstream of the last stage is cooled down to a temperature of less than −50° C. in a first heat exchanger E by heat exchange with at least one fluid resulting from the cold separation. This exchanger E can be of plate and fin type made of brazed aluminum.

The gas flow 1 is partially condensed in the first heat exchanger E and the two-phase flow formed is separated in a phase separator S, forming a gas 3 enriched in the at least one lighter component, in this instance at least nitrogen. This gas is heated in the first exchanger E up to a temperature greater than ambient temperature, for example greater than 30° C., and is subsequently heated in the first cooler R4 directly following the last stage C4 of the compressor from a temperature of 30° C. up to a temperature of 100° C., being the only cooling fluid sent to this first cooler R4. Subsequently, the gas cooled in the first cooler R4 is cooled in a second cooler R5 against cooling water CW to an ambient temperature of less than 40° C., indeed even of less than 30° C.

Alternatively, the gas flow 3 enriched in the at least one light component can cool the compressed gas in the second cooler R5, the first being cooled by water.

Alternatively or in addition, the flow enriched in the at least one light component can cool the compressed gas in a cooler R1, R2, R3 between two stages of the compressor.

Thus, the gas 3 to be expanded in a turbine T is preheated against the gas compressed in the compressor C1 to C4, so that the heat of compression makes it possible to produce more energy in the turbine.

The gas flow 3 enriched in light component heated in the first cooler R4 is at 8 bar and is expanded in the turbine T from this pressure down to approximately atmospheric pressure. The gas flow enriched in light component 3 can subsequently be used to regenerate adsorbents for drying the gas feeding the PSA to produce the flow 1. In addition or alternatively, the expanded flow 3 can feed the PSA unit to recover the CO₂ which it contains.

The liquid 5 from the phase separator S is expanded and subsequently sent to the top of a distillation column C from which a liquid 9 enriched in CO₂ and depleted in the at least one light component is withdrawn at the bottom. At least a part of the liquid is pressurized by a pump P and can be sent to be vaporized in the first heat exchanger E, a part 11 of the vaporized liquid optionally being sent to the bottom of the column C as reboiling and the other part 19 being sent to feed the column N at the bottom. The top gas 7 from the column C is heated in the first exchanger E.

The column N is a column for the removal of NOx compounds which are heavier than CO₂, NOx being a designation covering the following compounds: nitric oxide (NO), nitrogen dioxide (NO₂), nitrous oxide (N₂O), dinitrogen tetroxide (N₂O₄) and dinitrogen trioxide (N₂O₃). As NO is lighter than CO₂, the column N is used to remove nitrogen dioxide (NO₂), nitrous oxide (N₂O), dinitrogen tetroxide (N₂O₄) and dinitrogen trioxide (N₂O₃), if present in the liquid.

In this column fed by the flow 19, at least one impurity heavier than CO₂ is scrubbed out by an intermediate reflux of CO₂ 15 and a top reflux 23 of pure CO₂ to produce at the bottom a liquid enriched in the at least one heavier impurity 25, such as NOx compounds, for example NO₂.

The liquid enriched in the at least one heavier impurity 25 is vaporized in the first exchanger E.

The top gas 21 from the column N constitutes the product purified in the at least one heavier impurity and is heated in the first exchanger E before being compressed in a first compression stage C5 driven by the turbine T. After cooling in R6, the flow is divided, a part 23 being condensed in the first exchanger E and the remainder 27 being compressed in the compression stages C6, C7 to form a pressurized gaseous product. The gas compressed in C7 constitutes the CO₂-rich gaseous product in this example.

The part 23 is returned at the top of the column N as reflux.

The exchanger E, the phase separator S and the column C are inside a thermally insulated chamber CB.

Two means of cold production are used:
A closed cycle in which CO₂ is compressed in a cycle compressor CC and returned to the first heat exchanger, where it is cooled, liquefied, separated and expanded in two different valves to form two flows at 5.5 and 9.5 bar abs. These two flows are heated in the first heat exchanger E to provide cold and are then returned to the cycle compressor CC.
Vaporization of the liquid 9 in the exchanger E.

Obviously, the system may comprise several phase separators, in series and/or in parallel and upstream of the distillation, and also at least one distillation column.

If the system does not comprise a column separator, the gas expanded in the turbine will be taken at the top of the distillation column.

Preferably, at least one of the cycle compressors CC and at least one product compressor C6, C7 are incorporated in a single compression machine.

The turbine can drive at least one refrigeration cycle compressor, for example CC, and/or at least one other product compressor C6, C7, in addition to or in place of the compressor C5.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-15. (canceled)

16. A process for the low-temperature separation of a gas containing CO₂ to produce a CO₂-rich fluid, the process comprising the steps of:
compressing a gas containing CO₂ and at least one component lighter than CO₂ in a compressor comprising at least two stages to form a compressed gas,
cooling the compressed gas to form a cooled gas, wherein the step of cooling the compressed gas further comprises cooling the compressed gas in a first cooler, a second cooler that is configured to exchange heat with water, and a first heat exchanger to form the cooled gas;
separating the cooled gas at low temperature by partial condensation to produce a liquid and a gas, wherein the liquid is enriched in CO₂ and depleted in the component lighter than CO₂, wherein the gas is depleted in CO₂ and enriched in the component lighter than CO₂,
heating the gas depleted in CO₂ in the first heat exchanger and subsequently in the first cooler before being expanded in a turbine; and
separating the liquid enriched in CO₂ by distillation to form at least one CO₂-rich fluid.

17. The process as claimed in claim 16, wherein the at least one CO₂-rich fluid is a liquid and at least a part of the CO₂-rich fluid is vaporized in the first heat exchanger.

18. The process as claimed in claim 17, wherein the at least one vaporized CO₂-rich fluid is compressed in a compressor driven by the turbine.

19. The process as claimed in claim 17, wherein the liquid enriched in CO₂ is expanded and sent to the top of a stripping column and the at least one CO₂-rich fluid is a bottom liquid from the stripping column.

20. The process as claimed in claim 16, wherein the liquid enriched in CO₂ is fed to the top of a scrubbing column and the liquid from the scrubbing column feeds a distillation column.

21. The process as claimed in claim 20, wherein a top gas from the distillation column is compressed in a compressor driven by the turbine.

22. The process as claimed in claim 16, wherein the gas depleted in CO₂ goes into the cooler at a temperature greater than ambient temperature, for example greater than 30° C.

23. The process as claimed in claim 16, wherein the gas to be separated is separated by partial condensation to produce the gas depleted in CO₂ and also a liquid; the liquid is separated by distillation in a distillation column to produce the CO₂-rich fluid, which is preferably a CO₂-rich liquid.

24. The process as claimed in claim 16, wherein at least a part of the cold is provided by a closed refrigeration cycle comprising at least one cycle compressor driven by the turbine.

25. The process as claimed in claim 16, wherein at least one CO₂-rich fluid is a gas which is heated in the first heat exchanger E before being compressed.

26. An apparatus for the low-temperature separation of a gas containing CO₂ to produce a CO₂-rich fluid comprising:
a compressor comprising at least two stages;
a cooler in fluid communication with an outlet of the compressor, such that the cooler is configured to receive a compressed gas from the outlet of the compressor;
a water cooler in fluid communication with an outlet of the cooler, such that the water cooler is configured to receive gas from the outlet of the cooler;
a first heat exchanger in fluid communication with an outlet of the water cooler, such that the first heat exchanger is configured to receive gas from the outlet of the water cooler and to at least partially condense the gas to form a dual phase fluid;
a phase separator in fluid communication with the first heat exchanger, wherein the phase separator is configured to receive the dual phase fluid from the first heat exchanger and separate the dual phase fluid into a gas and a liquid, wherein the liquid is enriched in CO₂ and depleted in the component lighter than CO₂, wherein the gas is depleted in CO₂ and enriched in the component lighter than CO₂;
at least one distillation column configured to receive the liquid enriched in CO₂, wherein the at least one distillation column is configured to produce at least one CO₂-rich fluid;
means for sending the gas depleted in CO₂ to be heated first in the first heat exchanger and subsequently in the cooler, thereby forming a hot gas depleted in CO₂; and
a turbine configured to receive the hot gas depleted in CO₂ from the cooler and expand the hot gas depleted in CO₂ to form an expanded gas;

27. The apparatus as claimed in claim 26, further comprising a cycle compressor coupled to the turbine.

28. The apparatus as claimed in claim 26, further comprising a CO₂-rich product compressor coupled to the turbine.

29. The apparatus as claimed in claim 28, further comprising means for liquefying a part of the gas compressed in the CO₂-rich product compressor and means for sending the liquefied gas to the at least one distillation column as reflux.

30. The apparatus as claimed in claim 26, wherein the at least one distillation column comprises a first distillation column and a second distillation column, wherein the first distillation column is fed with the liquid enriched in CO₂ coming from the phase separator, and the second distillation column is fed with a bottom liquid from the first distillation column, wherein the second distillation column is configured to remove NOX.
